(19) United States
(12) Patent Application Publication
(10) Pub. No.: US 2010/0082332 A1
(43) Pub. Date: Apr. 1, 2010

(54) METHODS AND APPARATUS FOR PROTECTING USERS FROM OBJECTIONABLE TEXT

(75) Inventor: Robert Charles Angell, West Greenwich, RI (US)

Correspondence Address: RYAN, MASON & LEWIS, LLP, 1300 POST ROAD, SUITE 205, FAIRFIELD, CT, 06824, US

(73) Assignee: Rite-Solutions, Inc., Pawcatuck, CT (US)

(21) Appl. No.: 12/566,984

(22) Filed: Sep. 25, 2009

Related U.S. Application Data
(60) Provisional application No. 61/100,376, filed on Sep. 26, 2008.

(51) Int. Cl. G06F 17/27

(52) U.S. Cl. 704/9

(57) ABSTRACT

Methods and apparatus are provided for protecting users from objectionable text. Users are protected from objectionable text, by obtaining a predefined acceptable word list containing a plurality of acceptable words; receiving a textual entry from at least one user; and limiting the textual entry to only the acceptable words. The acceptable word list may comprise a dictionary of the acceptable words, and can be maintained by a central server or by a client associated with at least one of the users. The textual entry can be limited by only allowing the user to enter a subsequent character following entry of one or more entered characters if the subsequent character following the one or more entered characters comprises at least a portion of one of the acceptable words. The acceptable word list can optionally be updated with one or more additional acceptable words. The acceptable word list optionally comprises a context sensitive word list or one or more context sensitive rules.

### CROSS-REFERENCE TO RELATED APPLICATIONS

This application claims priority to U.S. Provisional Application Ser. No. 61/100,376, filed Sep. 26, 2008, incorporated by reference herein.

### FIELD OF THE INVENTION

The present invention relates generally to techniques for filtering text and other media, and more particularly, to methods and apparatus for protecting users from objectionable text.

### BACKGROUND OF THE INVENTION

As children are increasingly exposed to electronic media, there is a growing need to protect them and other users from objectionable text. For example, when exchanging text messages or instant messages, there is a significant risk to children due to a number of threats. For example, if not properly protected when doing these activities, children can be exposed to abusive language, vulgarity, sexual content, bullying, predatory content and other threats.

A number of techniques have been proposed or suggested for protecting children and other users from these threats. For example, a number of techniques employ filtering techniques to prevent known or identified “bad” things from being presented to protected users. Generally, if a word or other object is on a list of “blocked” content, the word or object will not be presented to the user. These filtering techniques generally require the controlling authority to remain in constant vigilance to ensure that the blocked content is sufficiently robust to prevent the undesired behavior. Attackers, however, are often encouraged to circumvent the blocks by finding new objectionable material that is not on the blocked list.

A need therefore exists for improved techniques for protecting users from objectionable text. A further need exists for techniques for protecting users from objectionable text that are not easily circumvented by attackers.

### SUMMARY OF THE INVENTION

Generally, methods and apparatus are provided for protecting users from objectionable text. According to one aspect of the invention, users are protected from objectionable text, by obtaining a predefined acceptable word list containing a plurality of acceptable words; receiving a textual entry from at least one user; and limiting the textual entry to only the acceptable words. The acceptable word list may comprise a dictionary of the acceptable words, and can be maintained by a central server or by a client associated with at least one of the users.

The textual entry can be limited by only allowing the user to enter a subsequent character following entry of one or more entered characters if the subsequent character following the one or more entered characters comprises at least a portion of one of the acceptable words. The acceptable word list can optionally be updated with one or more additional acceptable words. The acceptable word list optionally comprises a context sensitive word list or one or more context sensitive rules.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of an exemplary objectionable text filtering system incorporating features of the present invention;

FIGS. 2 and 3 are sample tables illustrating exemplary character entries using an acceptable word dictionary; and

FIG. 4 is a flow chart describing an exemplary implementation of an objectionable text filtering process incorporating features of the present invention.

### DETAILED DESCRIPTION

The present invention provides improved methods and apparatus for protecting users from objectionable text. Generally, the disclosed objectionable text filtering techniques use an acceptable word list that only allows a user to enter accepted words and phrases. Existing predictive text entry and word completion techniques are leveraged that reference a dictionary of commonly used words. As discussed further below, as the user enters text, a dictionary is searched for a list of possible words that match the entered characters, and one or more possible subsequent choice(s) are suggested. The user can then optionally confirm the selection and move on, or use a key to cycle through the suggested options. To attempt predictions of the intended result of characters not yet entered, predictive text can be combined with a word completion tool.

According to one aspect of the present invention, the user is not allowed to transition from the predictive entry technique into a free-form entry. For example, if the user wishes to enter the word “stupid” and “stupid” is not in the dictionary, but “stupendous” is in the dictionary, then as the user entered the letters “stup,” the only letter available to enter after the “p” would be an “e.” With this design, the list of words that are acceptable can be expanded, as desired and appropriate, but if a word is not in the approved list, it cannot be entered.

According to another aspect of the invention, the disclosed objectionable text filtering techniques can optionally utilize a dynamic, context sensitive word list. In this manner, the disclosed objectionable text filtering system would allow the user to enter a word or phrase that is acceptable in context, but might otherwise be unacceptable in another context. For example, the phrase “I hate ice cream” might be considered acceptable by only allowing the user to enter certain predefined acceptable words after the word “hate,” such as “ice cream” or “fall days,” while other predefined unacceptable words following the word “hate” would not be allowed, such as the word “foreigners” or named individuals or groups. In a further variation, context sensitive rules can be implemented in conjunction with the acceptable word dictionary.

In one embodiment, the disclosed objectionable text filtering system could function similar to the above-described existing auto complete applications but simply in a more rigid manner by only allowing the user to enter authorized letters. In the above phrase example, the user would enter “I hate f” and then the only letter that would be acceptable would be the “a.”

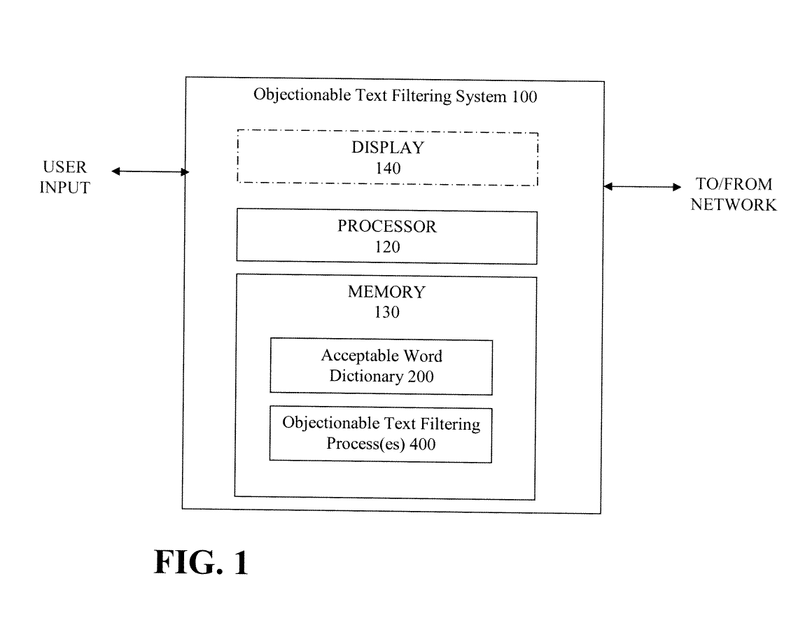

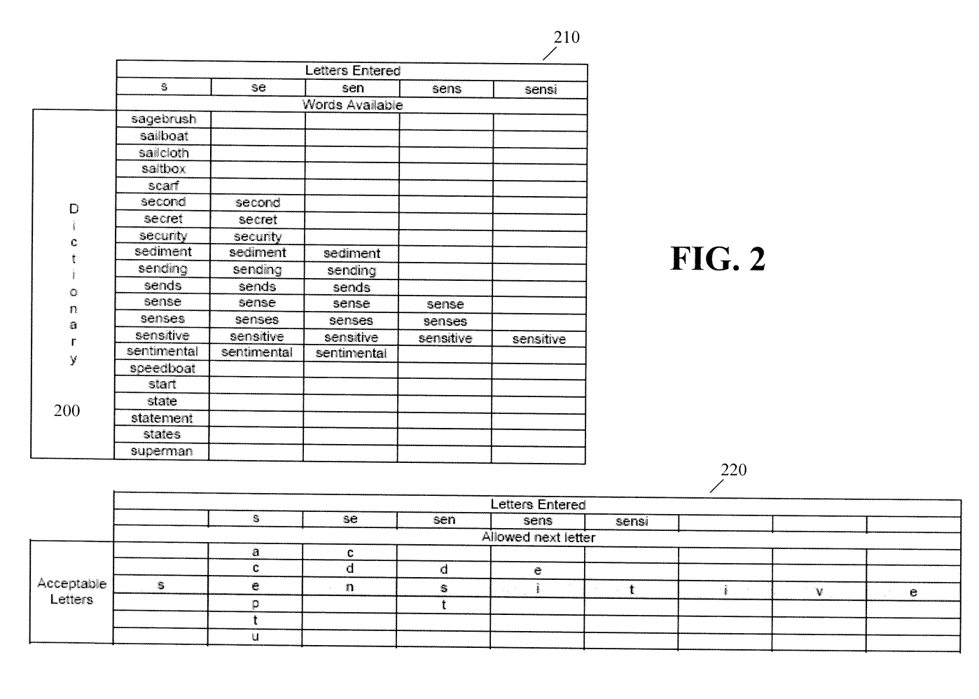

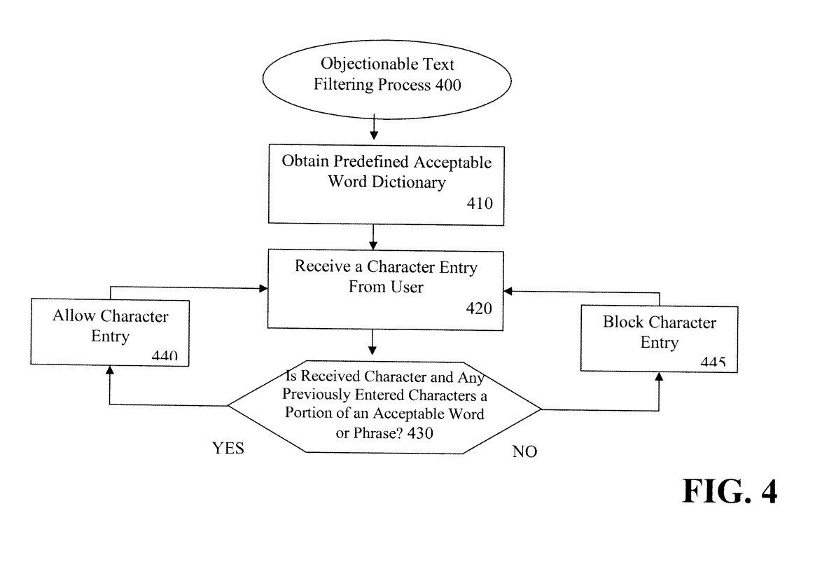

FIG. 1 is a schematic block diagram of an exemplary objectionable text filtering system 100 incorporating features of the present invention. As shown in FIG. 1, the exemplary objectionable text filtering system 100 comprises a processor 120, a memory 130 and an optional display 140. The memory 130 configures the processor 120 to implement the objectionable text filtering methods, steps, and functions disclosed herein (collectively, shown as 400 in FIG. 1, and discussed further below in conjunction with FIG. 4). The objectionable text filtering processes 400 employ one or more acceptable word dictionaries 200, discussed below in conjunction with FIG. 2. The memory 130 could be distributed or local and the processor 120 could be distributed or singular. The memory 130 could be implemented as an electrical, magnetic or optical memory, or any combination of these or other types of storage devices. It should be noted that each distributed processor that makes up processor 120 generally contains its own addressable memory space. It should also be noted that some or all of computer system 100 can be incorporated into a personal computer, laptop computer, handheld computing device, application-specific circuit or general-use integrated circuit.

The objectionable text filtering system 100 can be implemented using browser-based or client implementations. In this manner, the objectionable text filtering system 100 can be integrated into a variety of applications.

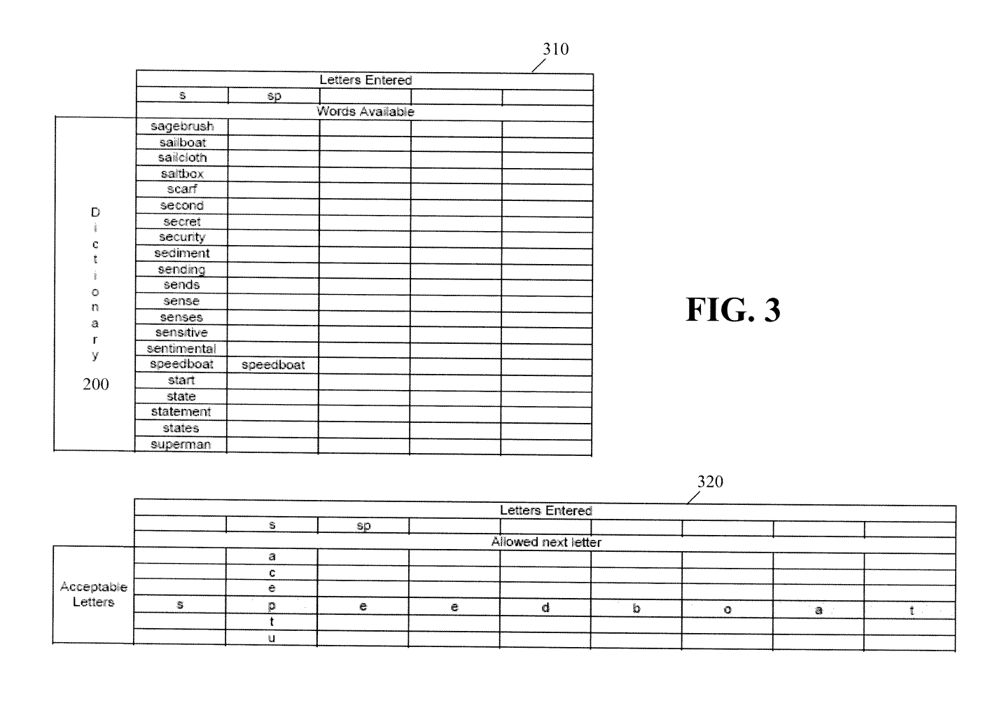

FIGS. 2 and 3 are sample tables illustrating exemplary character entries using an acceptable word dictionary 200. In various embodiments, the dictionary 200 can be maintained, for example, by a central server (not shown) or locally in the objectionable text filtering system 100 (FIG. 1). Generally, as the user enters text, the dictionary 200 is searched for a list of possible words that match the entered characters, and the user is allowed to only enter subsequent characters that will complete one or more words that are found in the dictionary 200. The acceptable word dictionary 200 is generally comprised of commonly used words that have been found to be acceptable. For example, a parent, teacher or guardian can monitor and maintain the acceptable word dictionary 200, when the acceptable word dictionary 200 is maintained locally for the user. In a server-based implementation, an acceptable word dictionary 200 that is specific to the user can be maintained remotely by a parent, teacher or guardian. In an alternate server-based implementation, a single acceptable word dictionary 200 can be maintained for multiple users, for example, by an authorized employee of an entity that provides the centralized monitoring service or by a school representative.

FIGS. 2 and 3 illustrate a subset of the acceptable word dictionary 200 with words starting with the letter “s.” As the user enters “s” as the first letter of a new word, the dictionary 200 is searched for a list of possible words that start with the letter “s,” and the user is allowed to only enter subsequent characters that will complete one or more words starting with the letter “s” that are found in the dictionary 200.

In the example of FIG. 2, when the user enters the “s”, there are 21 possible words that exist in the exemplary dictionary 200. Once the user enters the letter “s,” the user is able to enter only the letters a, c, e, p, t, or u as the user types, as shown in table 220, to continue down the word tree. Assuming that the user enters the letter “e” following the initial “s,” the user may only enter c, d, or n as the next letter. This process continues, as shown in table 210, until the user has entered “sensi” at which point the user may only continue by entering “tive” to form the word “sensitive.” A specific implementation may in fact complete the word once there are no more alternative letters that they may enter therefore speeding the process of word entry.

In the example of FIG. 3, when the user again enters the “s” as the initial characters, there are again 21 possible words that exist in the exemplary dictionary 200. Once the user enters the letter “s,” the user is able to enter only the letters a, c, e, p, t, or u as the user types, as shown in table 320, to continue down the word tree. Assuming that the user enters the letter “p” following the initial “s,” the user may only enter e as the next letter. At that point the user can enter nothing else other than “speedboat,” as shown in table 310. Again, an alternative implementation may complete the word for the user to speed entry since they can use no other letters.

The acceptable word dictionary 200 can optionally be updated over time, for example, based on attempted usage by a user. If a user attempts to enter a word that is not in the acceptable word dictionary 200, an approval request can be sent to an authorized individual, such as a parent, teacher or guardian, when locally maintained, or an authorized school employee or employee of an entity that provides a centralized monitoring service. The approval request can identify the attempted word that was not previously in the acceptable word dictionary 200 and request that the authorized individual approve the addition of the attempted word to the acceptable word dictionary 200.

FIG. 4 is a flow chart describing an exemplary implementation of an objectionable text filtering process 400 incorporating features of the present invention. As shown in FIG. 4, the objectionable text filtering process 400 initially obtains a predefined acceptable word dictionary containing a plurality of acceptable words during step 410.

Thereafter, the objectionable text filtering process 400 receives a character entry from the user during step 420. A test is performed during step 430 to determine if the received character together with any already entered characters forms a portion of an acceptable word or phrase in the dictionary.

If it is determined during step 430 that the entered character in combination with the previously entered characters is in the acceptable word dictionary, then the textual entry is allowed during step 440 and program control returns to step 420. If, however, it is determined during step 430 that the entered character in combination with the previously entered characters is not in the acceptable word dictionary, then the entered character is blocked during step 445 and program control returns to step 420, where the user can attempt a different character combination.

Among other benefits, the present invention provides a robust integrity implementation because only acceptable entries are permitted rather than trying to catch unacceptable ones. Therefore, the acceptable taxonomy can start off small and grow in a conservative manner rather than starting as an open environment and have to scramble to build restriction taxonomy as offensive practices are discovered. An additional benefit of this design is that it provides assistance to young children by assisting them in correctly completing words and phrases since it only allows them to enter the acceptable elements.

Process, System and Article of Manufacture Details

While one or more flow charts herein describe an exemplary sequence of steps, it is also an embodiment of the present invention that the sequence may be varied. Various permutations of the algorithm are contemplated as alternate embodiments of the invention. While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, application specific integrated circuit, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for protecting one or more users from objectionable text, comprising:
obtaining a predefined acceptable word list containing a plurality of acceptable words;
receiving a textual entry from at least one user; and
limiting said textual entry to only said acceptable words.

2. The method of claim 1, wherein said acceptable word list comprises a dictionary of said acceptable words.

3. The method of claim 1, wherein said acceptable word list is maintained by a central server.

4. The method of claim 1, wherein said acceptable word list is maintained locally by a client associated with at least one of said users.

5. The method of claim 1, wherein said step of receiving a textual entry further comprises the step of only allowing said at least one user to enter a subsequent character following entry of one or more entered characters if said subsequent character following said one or more entered characters comprises at least a portion of one of said acceptable words.

6. The method of claim 1, further comprising the step of updating said acceptable word list with one or more additional acceptable words.

7. The method of claim 1, wherein said predefined acceptable word list comprises a context sensitive word list.

8. The method of claim 1, wherein said predefined acceptable word list comprises one or more context sensitive rules.

9. An apparatus for protecting one or more users from objectionable text, the apparatus comprising:
a memory; and
at least one processor, coupled to the memory, operative to:
obtain a predefined acceptable word list containing a plurality of acceptable words;
receive a textual entry from at least one user; and
limit said textual entry to only said acceptable words.

10. The apparatus of claim 9, wherein said acceptable word list comprises a dictionary of said acceptable words.

11. The apparatus of claim 9, wherein said acceptable word list is maintained by a central server.

12. The apparatus of claim 9, wherein said acceptable word list is maintained locally by a client associated with at least one of said users.

13. The apparatus of claim 9, wherein said wherein said processor is further configured to only allow said at least one user to enter a subsequent character following entry of one or more entered characters if said subsequent character following said one or more entered characters comprises at least a portion of one of said acceptable words.

14. The apparatus of claim 9, wherein said processor is further configured to update said acceptable word list with one or more additional acceptable words.

15. The apparatus of claim 9, wherein said predefined acceptable word list comprises a context sensitive word list.

16. The apparatus of claim 9, wherein said predefined acceptable word list comprises one or more context sensitive rules.

17. An article of manufacture for protecting one or more users from objectionable text, comprising a machine readable storage medium containing one or more programs which when executed implement the steps of:
obtaining a predefined acceptable word list containing a plurality of acceptable words;
receiving a textual entry from at least one user; and
limiting said textual entry to only said acceptable words.

18. The article of manufacture of claim 17, wherein said step of receiving a textual entry further comprises the step of only allowing said at least one user to enter a subsequent character following entry of one or more entered characters if said subsequent character following said one or more entered characters comprises at least a portion of one of said acceptable words.

19. The article of manufacture of claim 17, further comprising the step of updating said acceptable word list with one or more additional acceptable words.

20. The article of manufacture of claim 17, wherein said predefined acceptable word list comprises a context sensitive word list.
